(19) United States
(12) Patent Application Publication
(10) Pub. No.: US 2002/0133462 A1
(43) Pub. Date: Sep. 19, 2002

(54) Instant electronic notification of credit card use serves as deterrent

(75) Inventor: Yevgeniy Eugene Shteyn, Cupertino, CA (US)

Correspondence Address: Michael E. Schmitt, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/811,191

(22) Filed: Mar. 16, 2001

(51) Int. Cl. G06F 17/60

(52) U.S. Cl. 705/44; 705/39

(57) ABSTRACT

A personal trusted device, such as a mobile phone, receives by default or conditionally an automatic notification when the user's credit card or its number is being used for a commercial transaction. The user can then instantly determine whether or not to instruct the credit card company to inactivate the card.

### FIELD OF THE INVENTION

The invention relates to a personalized electronic notification service.

### BACKGROUND ART

Currently, most credit card companies assume the liability for fraudulent use of credit card, or limit the damage to the registered and authorized user of the card, when the card gets used upon being stolen. The credit card company has, of course, to book the cost caused by the fraudulent use as a loss, that gets eventually taken into account in the monthly or other fee paid by all the users. The loss of a credit card is therefore to be notified to the credit card company as soon as possible in order to inactivate the card and to limit damages.

Identity theft has become a major threat of the electronic age. Identity theft occurs when someone appropriates another person's personal information without the person's knowledge to commit fraud or theft. Here are some ways that identity thieves work: They open a new credit card account, using another person's name, date of birth, and Social Security number. When they use the credit card and do not pay the bills, the delinquent account is reported on the first person's credit report. They call the credit card issuer and, pretending to be the first person, change the mailing address on the latter's credit card account. Then, the imposter runs up charges on the first person's account. Because the bills are being sent to the new address, the first person may not immediately realize there is a problem. The identity thieves establish cellular phone service in another person's name. They open a bank account in another person's name and write bad checks on that account. For more information see, e.g., the U.S. government's site at: http://www.consumer.gov/idtheft/ for more information.

### SUMMARY OF THE INVENTION

In general, the invention provides a method of providing a notification service regarding use of an object, especially a mobile or portable object. The service is provided to a legitimate user or owner of the object, and the notification is regarding the use of the object. The method comprises enabling to detect use of the object and enabling to communicate an electronic notification to a personal communication device of the user upon detection of the use. Preferably, one or more parties are enabled, in addition to the legitimate user, to be registered as recipient of the notification, e.g., in accordance with the preferences of the owner of the object. Also, preferably, the owner or another authorized party is enabled to specify a modality of the notification, e.g., via a mobile phone, a pager, an email to a PC, etc., or conditionally regarding time periods and/or location of the user, etc.

In a more specific embodiment of the invention, a service is provided to electronically notify a party (e.g., user, credit card company) of the use of a credit card or other electronic legal tender (e.g., cash card, phone card). The party can get notified instantly through, e.g., email, SMS, or pre-synthesized voice mail on the cell phone, when the card is being used for a transaction, whether the transaction is authorized or not. If the party is the authorized user of the card and is not aware of its being used, the user can take action immediately, e.g., via his/her cellphone or email to block the transaction. The cellphone could have a special alert function for this. If the user or the party who issued the card gets notified and the card has been reported as missing, then an automatic message to the local police station can be generated. This, in turn, can lead to the arrest of the unauthorized user if the notification is specific about time and location of the attempt to conclude an unauthorized transaction. The effect of this service is deterrence. If the user is the authorized user and the receiving party of the notification, the notification can simply be ignored.

Alternatively, or in addition, in order for the credit card transaction to be authorized, the user has to respond via the device receiving the notification, e.g., by entering a PIN code to be submitted, encrypted, to the authorizing service. By separating or distributing in space the checks in the system (signature, and electronic check) to allow electronic transactions by the authorized user, credit card usage is less liable to fraudulent usage by an occasional thief. Note that the legitimate user is typically the first person who is able to determine whether or not the notification relates to authorized or to unauthorized use of the credit card. The system can also be used to prevent identity theft. For that purpose, the user can set up a notification mechanism with regards to new objects issued to his/her name or a member of her family. For example, when a new credit card is issued, the credit card company can notify the user via an alternative mechanism associated with another card issued to the same user. In another example, a credit history-reporting agency can notify the user when a new record is entered or a request for credit verification is submitted. In this manner a virtual safe deposit box is created in order to protect the user from fraudulent access attempts.

Under “use of the object” as discussed above with respect to a credit card, is also meant to be understood the supply of the credit card number to a retailer or supplier via the Internet or the telephone. This on-line purchasing does not require the physical manipulation of the credit card, but only the card's number as its identification in the transaction. Again, upon the number being entered into the system, either by the legitimate or illegitimate user via the Internet, or by the receiving retailer, the notification service is initiated.

Credit card companies assume the liability for damages resulting from the unauthorized use. The credit card company benefits from the service as a deterrent to fraudulent card use. An aspect of the invention is therefore also comprised in the advertising of this service. Whether or not use of the card initiates the notification process cannot be inferred from the credit card itself. The mere advertising of the possibility that the users get notified instantly serves as a warning that unauthorized usage greatly increases the risks of being caught.

### BRIEF DESCRIPTION OF THE DRAWING

The invention is described in further detail, by way or example and with reference to the accompanying drawing, wherein:

FIG. 1 is a block diagram of functionalities in a system to provide the service of the invention; and

FIG. 2 is a block diagram of a personal communication device.

Throughout the drawing, same reference numerals indicate similar or corresponding features.

### DETAILED DESCRIPTION

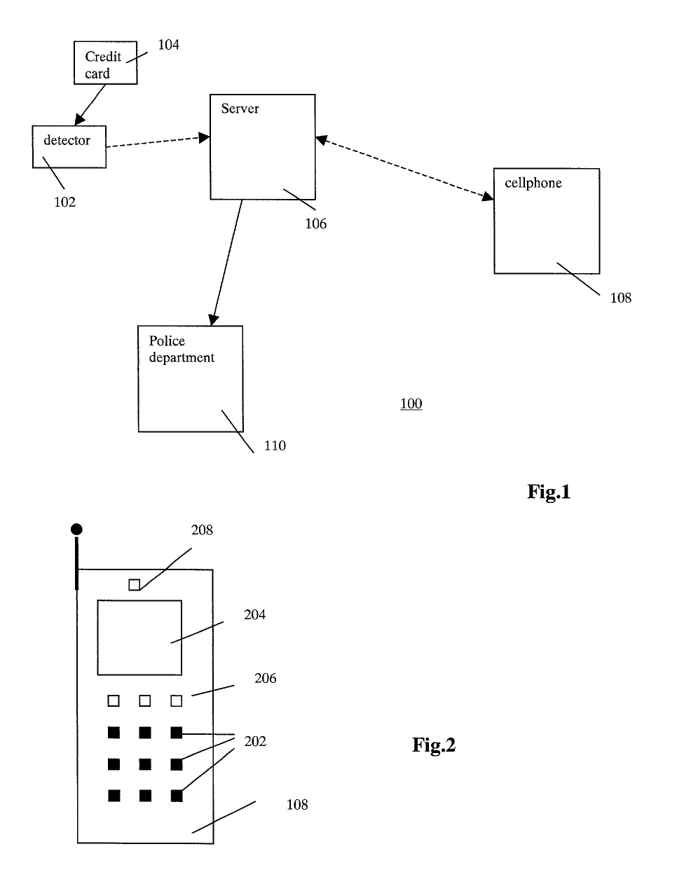

FIG. 1 is a diagram of a system 100 for implementing a service according to the invention. In this example, the use of a credit card is being monitored through a notification service.

System 100 comprises a detector 102, that detects the presence of a credit card 104 and determines its identity. Detector 102 can be a card reader for reading a magnetic strip of card 104, or another device that is typically used at a store to conclude a transaction with card 104. Upon detection of the identity of card 102, a message is sent to server 106, e.g., via the Internet or another data network. Preferably, a high degree of data encryption is used for communicating the card's identity and other relevant information to server 106. The authorized user of credit card 104 registered with server 106 on a previous occasion and has specified that he/she wants to be notified of the use of card 104 via a communication device 108, here a cellphone. As known, a cellphone has become a trusted personalized device that the user carries around with him/herself all the time. At registering with server 106, the user can specify a conditional notification. For example, the user can specify that he/she be notified by default, or always but during office hours, or upon an enabling-message from device 108 to server 106, etc.

Now, assume card 104 is being used for a transaction and interacts with detector 102. The latter sends a message to server 106 that checks the identity and authenticity of card 104, and whether its user has registered with the notification service. Assume that card 104 is a valid card and has not been reported as inactivated, and that the user has specified he/she be notified via cellphone 108 of the use of card 104. Server 106 then sends a notification to cellphone 108, e.g., as a synthesized voice message or as an SMS message, with information about the time of use (e.g., “8:20pm Tuesday March 13”), and its location (e.g., “Bay View Restaurant”). Assume that the use of card 104, which initiated this notification process, was by the authorized user. The user then can ignore the notification or the alert given by cellphone 108. Assume, on the other hand, that card 104 is being used illegitimately by a person other than the registered user. Now, the registered user gets notified via cellphone 108 and can intervene instantaneously. A hot button or a preprogrammed user-input from cellphone 108 confirms to server that the transaction is not legitimate. Server 106 notifies detector 102 and invalidates the authorization. At the same time, or upon explicit request from the user via cellphone 108, server 106 notifies, e.g., a police station 110 local to the reported location. This process of invalidating the card and notifying a law officer takes less than a few seconds upon detection, and chances are that the fraudulent person is going to be caught.

Detector 102, in above example, can comprise a physical detector. Alternatively, detector 102 comprises software that is a part of a smart form used by an on-line mail service. Upon a credit card number being entered, the software causes the number to be sent to server 106 for checking the registration for the notification service. The software can also be used as part of an Electronic docketing system at a mail-order retailer, who accepts credit card numbers over the telephone. Upon the number being entered into the docketing system, the software causes server 106 to be contacted for the notification service to the registered user.

A similar process of notification can be implemented for, e.g., monitoring use of a vehicle such as the user's car or motorcycle. In this case, starting the engine, or hampering with the doorlocks triggers a signal to be sent to a server, e.g., by a dedicated, built-in wireless communication device such as a pre-programmed data processing device combined with a wireless modem. The decision to follow up on the alert, i.e., to issue a conditional alarm and to immobilize the vehicle, is to be made by the authorized user or owner.

Also, a similar process can be implemented to monitor a security system of a house. For example, the opening of a door or a window may cause an alert to be issued whereupon the receiving party may decide what to do: trigger the alarm or ignore the alert. This type of security precaution may be used in parallel with the conventional security systems.

FIG. 2 is a block diagram of personal communication device 108, a mobile phone in this example. As known, mobile phones are increasingly more becoming personal trusted devices that go wherever the user goes. Accordingly, the trusted device in the invention has a dedicated feature in order to facilitate the user-interaction with the notification service discussed above. Phone 108 has a usual keypad 202 and an LCD 204. Phone 108 also has function keys 206, 208 and 210. A function key is programmable so as to provide a predefined function upon a single touch. For example, one of the function keys 206-210 is programmable to initiate the display of an SMS message on display 204 upon the user receiving an alert. Alternatively, a programmed function key initiates device 108 responding to server 106 in case the user receives an alert and wants the credit card to be inactivated, or an alarm to be triggered in the vehicle or home covered by the notification service.

Accordingly, the user is always or conditionally kept within the loop of the use of an object, over which he/she has authority, through a distributed notification system in a client-server architecture on a data network.

What is claimed is:

1. A method of providing a notification service to a legitimate user regarding use of an object of the user, the method comprising enabling to communicate an electronic notification to a personal communication device of the user upon detection of the use of the object.

2. The method of claim 1, comprising enabling a party other than the user to be registered as a recipient of the notification.

3. The method of claim 1, comprising enabling the user to specify a modality of the notification.

4. The method of claim 1, comprising enabling the user to electronically validate or invalidate the use of the object upon receipt of the electronic notification.

5. The method of claim 1, wherein the object comprises a credit card.

6. The method of claim 1, wherein the object comprises a vehicle.

7. The method of claim 1, wherein the object is a functional part of a building.

8. The method of claim 1, wherein the communication device comprises a mobile phone.

9. A method of providing a deterrent to unauthorized use of objects of authorized users, the method comprising advertizing that use of at least one of the objects initiates a sending of an electronic notification to a personal communication device of a relevant one of the authorized users.

10. A personal communication device for wireless communication of a predefined message to a server upon receipt of an alert and upon a user initiating the communication.
